(19) United States
(12) Patent Application Publication
(10) Pub. No.: US 2015/0271168 A1
(43) Pub. Date: Sep. 24, 2015

(54) METHOD, DEVICE, AND SYSTEM ESTABLISHING A WIRELESS COMMUNICATION CHANNEL BETWEEN ELECTRONIC DEVICES

(71) Applicants: CAPITALBIO CORPORATION, Beijing (CN); TSINGHUA UNIVERSITY, Beijing (CN)

(72) Inventors: Tao Sheng, Beijing (CN); Guanbin Zhang, Beijing (CN); Junmin Hao, Beijing (CN); Wanli Xing, Beijing (CN)

(21) Appl. No.: 14/438,590

(22) PCT Filed: Nov. 1, 2013
(86) PCT No.: PCT/CN2013/001326

§ 371 Date: Apr. 24, 2015

(30) Foreign Application Priority Data
Nov. 1, 2012 (CN) 201210431870.5

(51) Int. Cl. H04L 29/06; H04W 4/00; H04W 12/06

(52) U.S. Cl. CPC H04L 63/083; H04W 12/06; H04W 4/008; H04L 63/0876; H04W 84/18

(57) ABSTRACT

Provided herein are methods, devices, and systems of wireless communication. In one embodiment, a method for wireless communication between a first electronic device and a second electronic device includes: providing information symbols to the first electronic device, transmitting a pairing request from the first electronic device to the second electronic device, obtaining a pairing password by accessing a database, and establishing a wireless communication channel between the first electronic device and the second electronic device. In some embodiments, the information symbols are provided audibly or visually by the second electronic device and include a wireless communication address of the second electronic device. In some embodiments, the pairing pass word is obtained using the wireless communication address. In some embodiments, the wireless communication channel is obtained using the obtained pairing password.

### CROSS-REFERENCE TO RELATED APPLICATIONS

The present application claims the priority benefit to Chinese Application No. 201210431870.5, filed on Nov. 1, 2012, the content of which is incorporated by reference herein in its entirety for all purposes.

### TECHNICAL FIELD

The present disclosure relates to wireless communication, and more specifically, to methods, devices, and systems that establish a wireless communication channel between electronic devices.

### BACKGROUND

Short-range radio communication standards allow short-range communication between electronic devices. For the electronic devices to communicate, the devices must first set up a communication channel.

In the Bluetooth standard, a first electronic device scans for Bluetooth enabled devices within range and acquires a list of such devices. A desired second electronic device is selected by a user from the list and the first electronic device transmits a connection request to the second electronic device. A password for communication is requested of the user and, when the correct password is entered, a communication channel is opened between the first and second devices.

Heavy user involvement in establishing communication between the devices process is time consuming and can frequently result in errors.

### SUMMARY OF THE INVENTION

This disclosure provides methods, devices, and systems that establish a wireless communication channel between electronic devices.

In one embodiment, a method of wireless communication between a first electronic device and a second electronic device comprises: providing information symbols to the first electronic device, the information symbols provided audibly or visually by the second electronic device and comprising a wireless communication address of the second electronic device; transmitting a pairing request from the first electronic device to the second electronic device using the wireless communication address; obtaining a pairing password by accessing a database; and establishing a wireless communication channel between the first electronic device and the second electronic device using the obtained pairing password.

In further embodiments, the information symbols comprise at least one of a two-dimensional code, a bar code, and a voice code. In some further embodiments, the information symbols are encrypted or encoded.

In some embodiments, providing information symbols comprises at least one of obtaining an optical representation of the information symbols, obtaining an audible representation of the information symbols, and receiving characters representing the information symbols.

In some embodiments, the method further comprises displaying a notification on the first electronic device that a wireless communication channel has been established.

In some embodiments, the method further comprises transmitting to the second electronic device at least one of an operation instruction and identification information of a third electronic device, and wherein the at least one of an operation instruction and the identification information instructions is encoded or encrypted.

In some embodiments, the method further comprises transmitting the operation instructions from the first electronic device to the second electronic device.

In some embodiments, the method further comprises transmitting the identification information of the third electronic device from the first electronic device to the second electronic device. In some further embodiments, the method further comprises establishing wireless communication between the third electronic device and the second electronic device based on the transmitted identification information. In some further embodiments, the transmitted identification information comprises at least one of a Bluetooth address of the third electronic device, an IP address of the third electronic device, and a MAC address of the third electronic device.

In some embodiments, the first electronic device is a master device and the second electronic device is a slave device in the wireless communication. In some further embodiments, the wireless communication channel is a Bluetooth communication channel.

In some embodiments, the wireless communication operates according to a short range radio communication standard. In some further embodiments, the standard is a Bluetooth standard. In some further embodiments, the standard is a Wi-Fi Direct standard. In some further embodiments, the wireless communication is configured to operate at a range of no more than 100 meters.

In one embodiment, a method of establishing a wireless communication channel based on Bluetooth technology comprises collecting information symbols from an execution terminal, obtaining Bluetooth address information of the execution terminal according to the information symbols, sending a pairing request that corresponds to the

Bluetooth address information, entering a preset pairing password, and establishing a wireless communication channel with the paired execution terminal. In some embodiments, specific information can be sent to the execution terminal through the established channel, so as to perform an appropriate action.

In some embodiments, the specific information is encoded or encrypted. In some embodiments, the specific information contains information associated with a third terminal. According to the specific information, the execution terminal may perform an appropriate action. For example, using the established wireless communication channel, specific terminal-related information is sent to the execution terminal, so that the execution terminal obtains at least another terminal communication address from the terminal-related information and establishes another wireless communication channel with the third terminal. In some further embodiments, the terminal-related information contains the address information, the name information, and the device type of the third terminal. In some further embodiments, the address information of the terminal contains the corresponding Bluetooth address, IP address and MAC address.

In some embodiments, the specific information includes operation instructions. The execution terminal may perform appropriate actions in accordance with the operation instructions using the established wireless communication channel. For example, the operation instructions are sent to the execution terminal, so that the execution terminal performs the corresponding operations.

In some further embodiments, the information symbols display on the execution terminal in the form of a two-dimensional code, a bar code, or audible information. In some embodiments, the information symbols comprise a coded or encrypted Bluetooth address.

In some embodiments, information collecting modules contain at least one of an image sampling unit used to obtain the images which comprise the information symbols displayed on the execution terminal, a voice information sampling unit used to receive voice information which corresponds to the information symbols associated with the execution terminal and further acquires the corresponding information symbols, and a character information entering unit used to receive character information which corresponds to the information symbols associated with the execution terminal and further acquires the corresponding information symbols.

Some embodiments also comprise notice modules which notify a user that the wireless communication channel is successfully established after channel creation modules have created the communication channel with the terminal.

In one embodiment, a first electronic device for wireless communication with a second electronic device comprises: an information collection module to collect information symbols provided audibly or visually by the second electronic device, the information symbols comprising a wireless communication address of the second electronic device; a data transmission module to wirelessly transmit a pairing request from the first electronic device to the second electronic device using the wireless communication address; and a database for storing a pairing password, wherein the database is accessed and the pairing password is retrieved, and wherein the wireless communication is established over a wireless communication channel when the retrieved pairing password corresponds to a preset password.

In some embodiments, the information symbols comprise at least one of a two-dimensional code, a bar code, and a voice code. In some embodiments, providing information symbols comprises at least one of obtaining an optical representation of the information symbols, obtaining an audible representation of the information symbols, and receiving characters representing the information symbols.

In one embodiment, a wireless communication system comprises a first electronic device; and a second electronic device providing audible or visual information signals, the information symbols comprising a wireless communication address of the second electronic device, wherein the first electronic device collects the information symbols and transmits a pairing request to the second electronic device based on the wireless communication address.

In one embodiment, a system establishes wireless communication channels based on Bluetooth technology, wherein the system contains a control terminal and at least one execution terminal. The control terminal collects an information symbol of the execution terminal. Subsequently a Bluetooth address of the execution terminal is obtained from the collected information symbol. Then, a pairing request is sent to the execution terminal corresponding to the Bluetooth address. A request is sent from the execution terminal to the control terminal seeking a pairing password. Utilizing a preset pairing password stored in the control terminal to respond to the request for a pairing password, the wireless communication channel between the control terminal and the execution terminal is established. Through the channel, specific implementation information is sent to the execution terminal. When the specific information is terminal information related to at least an additional terminal, address information of the at least one additional terminal is obtained from the specific information, and wireless communication channel associated with the at least one terminal can be established with the execution terminal. When the specific information is the operation instruction, the operation instruction is performed by the corresponding terminal.

The embodiments described herein may beneficially eliminate or reduce the time required to scan for the desired device and the time required for a user to manually select the desired device. The embodiments described herein may also beneficially eliminate or reduce the time required to manually enter the pairing password and/or improve the accuracy of entering the pairing password.

### BRIEF DESCRIPTION OF THE DRAWINGS

FIG. 1 depicts a flowchart of a method of wireless communication between a first electronic device and a second electronic device, in accordance with one embodiment.

FIG. 2 depicts a flowchart of a method of establishing a wireless communication channel based on Bluetooth, in accordance with one embodiment.

FIG. 3 depicts a flowchart of a method of establishing a wireless communication channel based on Bluetooth technology, in accordance with one embodiment.

FIG. 4 depicts a schematic diagram of an electronic device which establishes wireless communication with another wireless device, in accordance with one embodiment.

FIG. 5 depicts a schematic diagram of a device establishing a wireless communication channel based on Bluetooth technology, in accordance with one embodiment.

FIG. 6 depicts a schematic diagram of a wireless communication system, in accordance with one embodiment.

FIG. 7 is a schematic diagram of a system establishing a wireless communication channel based on Bluetooth technology, in accordance with one embodiment.

### DETAILED DESCRIPTION OF EXEMPLARY EMBODIMENTS

All patents, applications, published applications and other publications referred to herein are incorporated by reference in their entireties. If a definition set forth in this section is contrary to or otherwise inconsistent with a definition set forth in the patents, applications, published applications and other publications that are herein incorporated by reference, the definition set forth in this section prevails over the definition that is incorporated herein by reference

As used herein, the singular forms “a”, “an”, and “the” include plural references unless indicated otherwise. For example, “a” dimer includes one or more dimers.

It is understood that aspects and embodiments described herein include “consisting” and/or “consisting essentially of” aspects and embodiments.

Throughout this disclosure, various aspects are presented in a range format. It should be understood that the description in range format is merely for convenience and brevity and should not be construed as an inflexible limitation on the scope of the disclosure. Accordingly, the description of a range should be considered to have specifically disclosed all the possible sub-ranges as well as individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Discussed herein is wireless communication between a first and second electronic device. Such first and second devices could include, but are not limited to, a mobile phone and a handsfree headset, a mobile phone and a wireless communication compatible car stereo system, a wireless headset and an intercom, and a wireless communication enabled PC and an input or output device.

As used herein, the term module should be construed broadly to refer to software, hardware, or any suitable device, means, or mechanism to carry out the associated function. Although modules may be described separately, the functions of one or more modules may be combined into a single module. Such single modules may include a multi-core processor, for example. Similarly, the functions of one of the modules may be divided into multiple processors or multiple cores of a multi-core processor. In some embodiments, a module may be a software engine. In some embodiments, a module may be either or both of a software or a hardware component. For example, a software engine may be executed by a processor to provide a present password—either or both of the software engine or the processor can be considered to be the module described above in this instance. The software program can be executed by a CPU.

For explanatory purposes, exemplary embodiments are described below in conjunction with the figures. The embodiments may beneficially eliminate or reduce the time required to scan for a desired device when establishing wireless communication between two electronic devices. The embodiments may also beneficially eliminate or reduce the time required for a user to manually select a desired device. The embodiments described herein may also beneficially eliminate or reduce the time required to manually enter a pairing password and/or improve the accuracy of entering the pairing password.

Other objects, advantages and features will become apparent from the following specification taken in conjunction with the accompanying drawings.

In one embodiment, provided herein is a method of wireless communication between a first electronic device and a second electronic device, comprising: providing information symbols to the first electronic device, the information symbols provided audibly or visually by the second electronic device and comprising a wireless communication address of the second electronic device; transmitting a pairing request from the second electronic to the first electronic device using the wireless communication address; obtaining a pairing password by accessing a database; and establishing a wireless communication channel between the first electronic device and the second electronic device using the obtained pairing password.

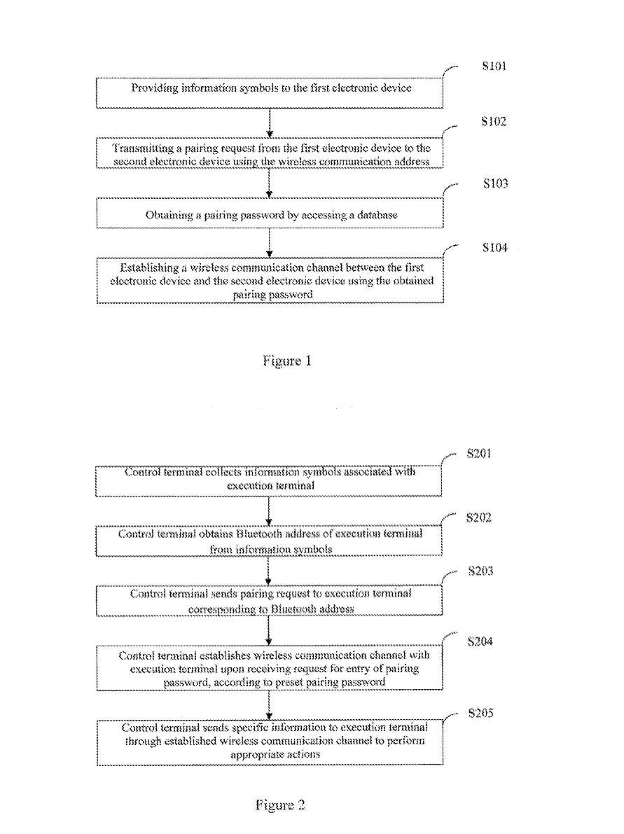

FIG. 1 depicts a flowchart of a method of wireless communication between a first electronic device and a second electronic device, in accordance with one embodiment.

In some embodiments, the information symbols comprise at least one of a two-dimensional code, a bar code, and a voice code. In some embodiments, the information symbols are encrypted or encoded. In some embodiments, providing information symbols comprises at least one of obtaining an optical representation of the information symbols, obtaining an audible representation of the information symbols, and receiving characters representing the information symbols.

As used herein, the term “information symbols” can be understood as photos, barcodes, voice, two-dimensional code, word or light, etc. These information symbols can be obtained by image capture device, sound capture device, optical emission device,“bumping” two mobile devices or inserting a memory stick, etc.

In some embodiments, the method further comprises displaying a notification on the first electronic device that a wireless communication channel has been established. In some embodiments, the method further comprises transmitting to the second electronic device at least one of an operation instruction and identification information of a third electronic device, and wherein the at least one of an operation instruction and the identification information instructions is encoded or encrypted.

In some embodiments, the method further comprises transmitting the operation instructions from the first electronic device to the second electronic device. In some embodiments, the method further comprises transmitting the identification information of the third electronic device from the first electronic device to the second electronic device.

In some embodiments, the method further comprises establishing wireless communication between the third electronic device and the second electronic device based on the transmitted identification information.

In some embodiments, the transmitted identification information comprises at least one of a Bluetooth address of the third electronic device, an IP address of the third electronic device, and a MAC address of the third electronic device.

In some embodiments, the first electronic device is a master device and the second electronic device is a slave device in the wireless communication. In some embodiments, the master-slave relationship can be understood as a “control-execution” relationship.

In some embodiments, the wireless communication channel is a Bluetooth communication channel.

In some embodiments, Bluetooth can be understood to include short range radio communication using microwave frequencies. In some further embodiments, Bluetooth can be understood to include short range communication at 2400-2500.

In some embodiments, the wireless communication operates according to a short range radio communication standard. In some embodiments, the standard is a Bluetooth standard. In some embodiments, the standard is a Wi-Fi Direct standard.

In some embodiments, the wireless communication is configured to operate at a range of no more than 100 meters.

In some embodiments, the password may be entered by at least one of accessing a database on the first electronic device, manually entering the password, or extracting the password from the information symbols.

FIG. 2 depicts a flowchart of a method of establishing a wireless communication channel based on Bluetooth, in accordance with one embodiment. FIG. 2 includes the following steps.

Step S201: The control terminal collects information symbols associated with the execution terminal.

The information symbols can be generated by encoding the Bluetooth address information of the execution terminal, encoding the IP address information, MAC address information, the name information, the device type of the execution terminal or a combination thereof. The information encoding process may be performed by an encoding/decoding application software. In some embodiments, the information symbol may not be encoded.

The information symbols may take a variety of representations, such as two-dimensional code, bar code or voice information symbols. In some embodiments, the information symbols are encoded and/or encrypted.

The information symbols of the execution terminal can be displayed on a display screen, or displayed on the control terminal in another form, such as spraying or pasting the information symbols on the shell of the control terminal.

The control terminal can obtain the information symbols of the execution terminal through a variety of methods. In one embodiment, the control terminal acquires the information symbols by taking a photo, a keyboard input, or a touch screen input. In some embodiments, the control terminal obtains the information symbols via a voice input.

Step S202: The control terminal obtains the Bluetooth address information of the execution terminal from the information symbols.

The control terminal may include an encoding/decoding application program. The encoding/decoding application program can decode and/or decrypt the information symbol to acquire the Bluetooth address information of the execution terminal. In some embodiments, the control terminal has the corresponding relationship between the information symbols and the Bluetooth address information of the execution terminal. Through the relationship, the control terminal can acquire the Bluetooth address of the execution terminal.

Step S203: The control terminal sends a pairing request to the execution terminal corresponding to the Bluetooth address information.

In some embodiments, the control terminal may include a sending application program. When the control terminal parses out the Bluetooth address information of the execution terminal, the sending application program automatically obtains the Bluetooth address information, and sends a pairing request to the corresponding execution terminal. In some embodiments, the control terminal may include a triggering device. When the control terminal parses out the Bluetooth address information of the execution terminal, the pairing request is generated by the triggering device.

Step S204: The control terminal establishes a wireless communication channel with the execution terminal upon receiving a request for entry of a pairing password, according to a preset pairing password.

In some embodiments, the control terminal may have the corresponding relationship between the Bluetooth address information of the execution terminal and the preset pairing password. Through the relationship, the control terminal can acquire the correct pairing password, and complete the establishment of the wireless communication channel.

In some embodiments, the control terminal may include a pairing application program associated with the execution terminal. The control terminal may receive the request for entering the pairing password, call the pairing application program to enter the correct pairing password, so as to establish the wireless communication channel.

In some embodiments, the encoding/decoding application program, sending application program and pairing application program may be different functions of the same application program. In some embodiments, they may be three different application programs. Both the control terminal and execution terminal may contain the application programs. There may be a correlation between the application programs of the control terminal and the application programs of the execution terminal. For example, the decoding application program of the control terminal matches the encoding applications program of the execution terminal, and on the other hand, the encoding application program of the control terminal matches the decoding application program of the execution terminal. In some embodiments, the control terminal may only have the decoding application program, sending application program and pairing application program, and the execution terminal may only have the encoding application program. The control terminal may also act as an execution terminal, and the execution terminal may similarly act as a control terminal. The execution terminal may also have a decoding application program, sending application program and pairing application program, and the control terminal may also have an encoding application program.

Step S205: The control terminal sends specific information to the execution terminal through the established wireless communication channel to perform appropriate actions.

In some embodiments, the specific information is encoded or encrypted. In some embodiments, a method of establishing a wireless communication channel is based on the Bluetooth technology. In this embodiment, the control terminal directly obtains the information symbols of the execution terminal, and the time of searching for the execution terminal may be beneficially eliminated or reduced, while avoiding the time consumption associated with manual selection of the specific terminal. During the process of establishing a wireless communication channel, the control terminal may automatically enter the pairing password without manual manipulation, which may beneficially improve the accuracy of the pairing password, hence reducing the time consumption for establishing a wireless communication channel, and increasing the efficiency establishing a wireless communication channel. Embodiments may use the Bluetooth technology to establish a wireless communication channel, and expand the scope of the Bluetooth wireless communication application. By using the established wireless communication channel, the specific information is sent to the execution terminal, so that the execution terminal performs the appropriate actions.

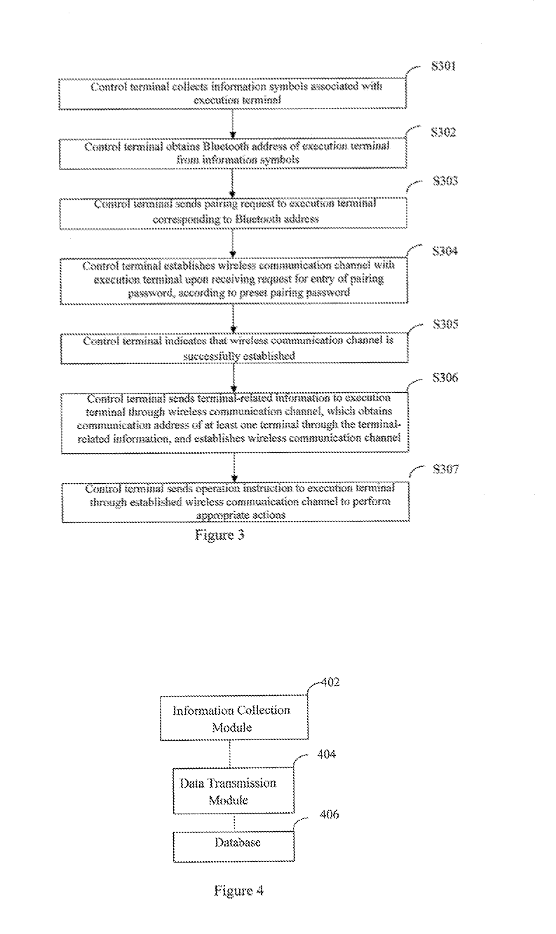

FIG. 3 depicts a flowchart of a method of establishing a wireless communication channel based on Bluetooth technology, in accordance with one embodiment. The method may include the following steps:

Step S301: The control terminal collects the information symbols of the execution terminal. There are many ways of collecting the information symbols of the execution terminal. While the information symbols may be displayed on the surface of the execution terminal, the control terminal can acquire a photo, and obtain the information symbols of the execution terminal from the photo. In some other embodiments, the voice acquisition port of the control terminal acquires the information symbols in the form of a voice mode. The voice information is analyzed to acquire the information symbols associated with the execution terminal. In some embodiments, character information is entered to the control terminal through a touch screen or keyboard of the control terminal and the character information is then analyzed to acquire the information symbols associated with the execution terminal.

Step S302: The control terminal obtains the Bluetooth address information of the execution terminal from the information symbols.

Step S303: The control terminal sends a pairing request to the execution terminal corresponding to the Bluetooth address information.

Step S304: The control terminal establishes a wireless communication channel with the execution terminal upon receiving a request for entry of a pairing password, according to a preset pairing password.

Step S305: The control terminal indicates that the wireless communication channel is successfully established.

There are several ways of indicating that the wireless communication channel is successfully established, such as visible signal or audio signal appears on the interface of the control terminal and/or the execution terminal. This may be an optional feature in some embodiments.

Step S306: The control terminal sends a terminal-related information to the execution terminal through the wireless communication channel, which obtains a communication address of at least one terminal through the terminal-related information, and establishes a wireless communication channel with a terminal from the at least one terminal.

In some embodiments, the specific information may be a terminal-related information, and the communication address information may be Bluetooth address, Wi-Fi address, etc. The terminal-related information may contain a terminal address, a terminal name, a device type of the terminal, or a combination thereof. The terminal address may include a Bluetooth address, IP address, MAC address or a combination thereof.

In some embodiments, the terminal-related information may be the related information of the control terminal. When the wireless communication channel between the control terminal and the execution terminal is disconnected, the execution terminal can use its own stored terminal-related information of the control terminal to acquire the address information of the control terminal, and then a wireless connection channel can be reestablished. The terminal-related information may be related information of other terminals. Similarly, the execution terminal can obtain the communication address information of the other terminal, and if necessary, a wireless connection channel with the other terminal can be established.

In some embodiments, the wireless connection channel established with the other terminals may be wireless communication channel or Wi-Fi connection channel. Here the kind of wireless connection channel is not particularly limited.

Step S307: The control terminal sends an operation instruction to the execution terminal through the established wireless communication channel to perform appropriate actions.

The specific information may also include operation instructions. The operation instructions may include switch command and/or other operation instructions that the control terminal achieves some functions.

The specific information of the control terminal may be information stored itself, or obtained from another terminal. For example, when the control terminal establishes a wireless communication channel with another terminal, the Bluetooth address information of the other terminal may be stored in itself.

The order between Step S306 and Step S307 may be switched, and is only presented here for illustration purposes. Some embodiments may include only Step S306 but not include Step S307, may only include Step S307 but not include Step S306, or may include both Step S307 and Step S306.

The method described with respect to FIG. 3 may have the advantages of other embodiments described herein, but may have additional advantages. These may include allowing the execution terminal to establish a wireless communication channel with other terminals, and after the wireless communication channel with the control terminals is disconnected, the wireless communication channel may be reestablished without the need to obtain information symbols of the execution terminal or other terminals again, thus further reducing the time of establishing a wireless communication channel and improves the efficiency of establishing the wireless communication channel. Nothing in this paragraph should be taken as a representation that other embodiments do not have the advantages described in this paragraph.

The above embodiment is described as a method, and the present disclosure can be implemented in various forms of device. The present disclosure also discloses another device, and the following embodiments are given to describe the device in detail.

FIG. 4 depicts a schematic diagram of an electronic device which establishes wireless communication with another wireless device, in accordance with one embodiment. First electronic device for wireless communication comprises an information collection module 402 to collect information symbols provided audibly or visually by a second electronic device, the information symbols comprising a wireless communication address of the second electronic device; a data transmission module 404 to wirelessly transmit a pairing request from the second electronic to the first electronic device using the wireless communication address; and a database 406 for storing a pairing password, wherein the database is accessed and the pairing password is retrieved, and wherein the wireless communication is established over a wireless communication channel when the received pairing password corresponds to a preset password.

In some embodiments, the information symbols comprise at least one of a two-dimensional code, a bar code, and a voice code.

In some embodiments, providing information symbols comprises at least one of obtaining an optical representation of the information symbols, obtaining an audible representation of the information symbols, and receiving characters representing the information symbols.

FIG. 5 depicts a schematic diagram of a device establishing a wireless communication channel based on Bluetooth technology, in accordance with one embodiment. The device may include the following sections: acquisition module 501, obtaining module 502, request module 503, establishing module 504 and data module 505.

In some embodiments, acquisition module 501 is used to collect information symbols of the execution terminal; the information symbols display on the execution terminal in the form of the two-dimensional code, the bar code or the voice information. Preferably, the information symbols are encoded or encrypted Bluetooth address.

In some embodiments, acquisition module 501 can have a variety of ways to collect the information symbols of execution terminal. The acquisition module 501 may include: an information collecting module which contains the image sampling unit used to obtain the image which comprises the information symbols displayed on the execution terminal; a voice information sampling unit used to receive the voice information which corresponds to the information symbols associated with the execution terminal and further acquires the correspond information symbols; a character information entering unit used to receive the character information which corresponds to the information symbols associated with the execution terminal and further acquires the correspond information symbols, or a combination thereof.

The obtaining module 502 may be used to obtain the Bluetooth address of the execution terminal according to the information symbols. The request module 503 may be used to send a pairing request according to the Bluetooth address based on the obtaining module 502.

The establishing module 504 is used to establish the wireless communication channel between the control terminal and the execution terminal according to the preset pairing password when receiving the direction of inputting pairing password.

The data module 505 may be used to establish wireless communication channel to send specific information to the execution terminal so that the specific information can be stored by the execution terminal.

In some embodiments, the specific information includes the terminal-related information or operation instructions.

When the specific information received is a terminal-related information, the data module 505 may be used to send specific implementation information to the execution terminal through the channel. When the specific information is terminal-related information, address information of at least one terminal is obtained from the specific information, and the wireless communication channel associated with the terminal can be established.

When the specific information received is an operation instruction, the data module 505 may be used to send operation instructions to the execution terminal.

The device may include notice module 506, which may be used to indicate that the wireless communication channel is successfully established after the establishing module 504 has created the communication channel with the execution terminal.

In one embodiment, a method establishing the wireless communication channel is based on the Bluetooth technology, wherein the control terminal directly obtains the information symbols of the execution terminal through the acquisition module 501. By using obtaining module 502 to obtain the Bluetooth address of the execution terminal, the time searching the execution terminal is eliminated, while avoiding the time consumption associated with manual selection of the specific terminal. When the establishing module 504 receives the instruction to enter the pairing password, the control terminal automatically enters the pairing password without manual manipulation, which improves the entering accuracy of the pairing password, hence reduces the time consumption establishing a wireless communication channel and increases the efficiency of establishing a wireless communication channel, and further by establishing a wireless communication channel, the specific information is sent to the execution terminal, so as to perform the appropriate actions.

The control terminal can control the execution terminal to perform corresponding action through the wireless communication channel, while the execution terminal may establish a wireless communication channel with another terminal according to the terminal-related information sent by the control terminal, or re-establish wireless communication channel with the control terminal without the need to reacquire information symbols of control terminal or other terminals, hence reducing the time consumption establishing a wireless communication channel and increases the efficiency of establishing a wireless communication channel.

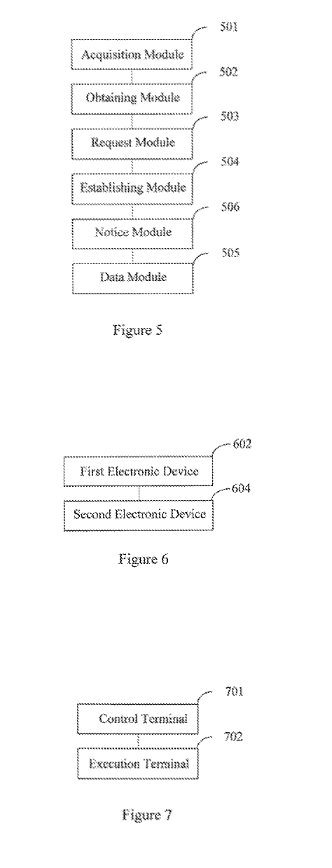

FIG. 6 depicts a schematic diagram of a wireless communication system, in accordance with one embodiment. The wireless communication system includes a first electronic device 602 and a second electronic device 604. Second electronic device 604 provides audible or visual information signals, the information symbols including a wireless communication address of the second electronic device. The first electronic device 602 collects the information symbols and transmits a pairing request to the second electronic device based on the wireless communication address.

FIG. 7 is a schematic diagram of a system establishing a wireless communication channel based on Bluetooth technology, in accordance with one embodiment. The system may include the following sections: a control terminal 701 and at least one execution terminal 702, in which:

The control terminal 701 collects information symbols from the execution terminal 702, obtains the Bluetooth address of the execution terminal 702 according to the information symbols; sends a pairing request to the execution terminal 702 according to the Bluetooth address; receives the instruction of pairing password input; and establishes a communication with the pairing execution terminal 702 in a wireless communication channel according to the preset password. Through the communication channel mentioned above the control terminal may send a specific information to the execution terminal 702. The execution terminal 702 may receive the specific information. When the specific information is a terminal-related information, execution terminal 702 may obtain at least one terminal address, and establish wireless connection channel with a terminal according the terminal-related information. When the specific information is an operating instructions, execution terminal 702 may execute the operation instruction.

Control terminal 701 can be a mobile phone, a computer, a tablet PC, a digital audio player or other personal digital devices.

In some embodiments, execution terminal 702 may be an industrial control equipment, an information signal acquisition device or a medical monitoring equipment, etc., with a Bluetooth transmission module.

The following examples are offered to illustrate but not to limit this disclosure.

### Example 1

In this example, the control terminal 701 is a cellphone or other mobile device; the execution terminal 702 is an electrocardiography (ECG) monitoring device which includes a symbol display device, memory and Bluetooth module. First, the ECG monitoring device pre-encoded the Bluetooth address of the Bluetooth module into a two-dimensional code information symbol and the two-dimensional code information symbol is sprayed on the surface of the shell of the ECG monitoring device. After the cellphone camera capturing the two-dimensional code information symbol, the ECG monitoring device's Bluetooth address is resolved by internal application software of the cellphone and the ECG monitoring device's Bluetooth address is saved. The cellphone begins pairing with the ECG monitoring device according to the obtained Bluetooth address. The cellphone sends the pairing request automatically to the ECG monitoring device. When the ECG monitoring device receives the cellphone's pairing request, a request to enter the pairing password is generated (the ECG monitoring device is provided with a password) and requires the cellphone to enter the same pairing password. The cellphone enters the correct pairing password automatically by application software in order to establish a wireless communication channel with ECG monitoring device.

The cellphone sends the specific information to the ECG monitoring device through the established wireless communication channel. The ECG monitoring device receives specific information which is the terminal-related information, at least one terminal Bluetooth address is obtained according to the terminal-related information. The ECG monitoring device can establish at least a wireless connection with one terminal mentioned above. For example, when the wireless communication channel between the cellphone and the ECG monitoring device is disconnected, the ECG monitoring device can establish a wireless communication channel with the cellphone according to its stored cellphone's Bluetooth address. At the same time, the control terminal of the ECG monitoring device turns into the execution terminal while the execution terminal of cellphone is converted to the control terminal. When receiving specific information which is the operating instruction, the ECG monitoring device performs the corresponding operation to complete the required functions of the operation instructions.

The ECG monitoring device and the cellphone can use the method depicted in FIG. 2 to establish a wireless communication channel for the first time. When establishing a wireless communication channel once again, it just needs to open the Bluetooth of the ECG monitoring device and the cellphone. After Bluetooth of the ECG monitoring device and the cellphone are established automatically, users do not need to perform time-consuming operation of Bluetooth connectivity.

### Example 2

In this example, the control terminal 701 is a cellphone or other mobile device; the execution terminal 402 is an electronic lock.

The Bluetooth address of the electronic lock is printed on the shell of the electronic lock as encrypted characters. When the cellphone user launches the application software and follows the screen prompts through the phone keypad or touch screen to enter encrypted characters of the electronic lock directly, the encoding/decoding application software of the cellphone may extract character information to obtain the electronic lock's Bluetooth address. The cellphone initiates a paring request based on the extracted Bluetooth address of the electronic lock. After the electronic lock receives the pairing request from the cellphone a request for inputting pairing password is generated (because of the setting of Bluetooth pairing password of the electronic lock, the same pairing password is requested to be entered by the cellphone), the pairing application software of the cellphone enters the correct password automatically and then a wireless communication channel between the cellphone and the electronic lock is established. The preset application softwares of the present embodiment (prompting application software, encoding/decoding application software, and pairing application software) are completed automatically without manual operations. The cellphone can establish a wireless communication channel to send instructions of unlocking or locking to the electronic lock, and these operating instructions may be preset in advance into the storage of the cellphone. The cellphone sends operating instructions in storage to the electronic lock through the established wireless communication channel, the electronic lock receives automatically and decodes the received operation instructions, and according to the decoded operation code performs a locking or unlocking operation. Thus, the electronic lock may be controlled by the cellphone through short-distance wireless remote communication.

### Example 3

In this example, the control terminal 701 is a cellphone or other mobile device, the execution terminal 702 is a video surveillance equipment.

The Bluetooth address of the video surveillance equipment is printed on the shell of the video surveillance equipment as encrypted characters. When the user launches the prompting application software and follows the screen prompts to enter encrypted character of the video surveillance equipment through voice, the encoding/decoding application software of the cellphone extracts character information to obtain the Bluetooth address of the video surveillance equipment. The cellphone initiates a paring request based on the extracted Bluetooth address of the video surveillance equipment. After the video surveillance equipment receives the pairing request from the cellphone a request for inputting pairing password is generated (because of the setting of Bluetooth password of the video surveillance equipment, the same pairing password are requested to be entered by the cellphone). The pairing application software of the cellphone enters the correct pairing password automatically and then completes a wireless communication channel between the cellphone and the video surveillance equipment. The steps of the present embodiment are completed automatically by the preset application software without manual operation.

In some embodiments, the operation instructions of the video surveillance equipment can be set as specific information in the cellphone (such as turning on camera, shutting off camera, switching between photo and video) and pre-set in the storage of the cellphone.

By establishing a wireless communication channel to send operation instructions in storage to the video surveillance equipment, the video surveillance equipment receives automatically and decodes the received operation instructions and according to the decoded operation code of operations (such as turning on camera, shutting off camera, switching between photo and video), the video surveillance equipment may be controlled by the cellphone through short-distance wireless remote communication.

### Example 4

This example involves two execution terminals: execution terminal A and execution terminal B. The control terminal 701 is a tablet PC or other mobile device; the execution terminal A is an industrial control equipment, the execution terminal B is a cellphone or other mobile device.

The process to establish a wireless communication channel between the tablet PC and the industrial control equipment is similar to the three examples mentioned above. The steps after establishing a wireless communication channel between the tablet PC and the industrial control equipment are described below.

The cellphone's Bluetooth address may be the specific information stored in the tablet PC. The tablet PC and the industrial control equipment have been connected through a wireless communication channel and the stored specific information is sent to the industrial control equipment. The industrial control equipment automatically receives the specific information and decodes the specific information to obtain the Bluetooth address of the cellphone, and stores the Bluetooth address of the cellphone. After the wireless communication channel established between the industrial control equipment and the tablet PC is disconnected, if necessary, the industrial control equipment may actively establish a wireless communication channel with the cellphone through the Bluetooth address of cellphone. In the present embodiment, the tablet PC is used as a medium to achieve the purpose of establishing a wireless communication channel quickly between the industrial control equipment and the cellphone.

### Example 5

This example involves three execution terminals: execution terminal A, execution terminal B and execution terminal C. The control terminal 701 is a cellphone or other mobile device; the execution terminal A and execution terminal B are industrial control equipment and execution terminal C is a tablet PC or other mobile device.

The cellphone and industrial control equipment A (execution terminal A) can establish a wireless communication channel using the same method mentioned above, while the cellphone and industrial control equipment B (execution terminal B) can also establish a wireless communication channel using the same method mentioned above. Here the steps after establishing wireless communication channels for the cellphone, execution terminal A, and execution terminal B are described.

The tablet PC's Bluetooth address, and the command codes for the industrial control equipment A and the industrial control equipment B are specific information preset in the cellphone's storage. The cellphone, industrial equipment A and/or industrial equipment B have been connected through the established wireless communication channels. The stored specific information of the industrial control equipment A and/or industrial control equipment B is sent to industrial control equipment A and/or industrial control equipment B by the cellphone. The industrial control equipment A and/or industrial control equipment B automatically receives and decodes the specific information to obtain the Bluetooth address of the cellphone, and the command code of industrial control equipment A and/or industrial control equipment B. The industrial control equipment A and/or industrial control equipment B stores the Bluetooth address of the cellphone and the command code of operations.

If necessary, industrial control equipment A and/or industrial control equipment B performs the operations according to the decoded operation instruction (such as turning on a device, turning off a device, timing a device, modifying the speed of a device, etc.).

In the present embodiment, the industrial control equipment A and/or industrial control equipment B may be controlled by the cellphone through short-distance wireless remote communication.

When the wireless communication channel established for industrial control equipment A and/or industrial control equipment B and the cellphone is disconnected, if necessary, industrial control equipment A and/or industrial control equipment B will actively establish a wireless communication channel with the tablet PC using the Bluetooth address of the tablet PC. In the present embodiment, the cellphone is used as a medium to achieve the purpose of establishing a wireless communication channel quickly between the industrial control equipment A and/or industrial control equipment B and the tablet PC.

The various embodiments of the specification are described progressively. Each embodiment emphasizes the differences from other embodiments. The same or similar parts of embodiments may be referred from each other. For the embodiments of the disclosed devices, because of the descriptions of the disclosed devices and methods in the embodiments correspond to each other, the descriptions are relatively simple, and may be referred from the descriptions for the methods.

In combination with the presently disclosed embodiments, the steps of the methods or algorithms can be directly implemented by hardware, software module executed by a processor, or a combination thereof. Software modules can be placed in a random access memory (RAM), a memory, a read only memory (ROM), an electrically programmable ROM, an electrically erasable programmable ROM, a registers, a hard disk, a removable disk, a CD-ROM, or any other form of storage medium known in the art.

The embodiments described above may operate on one or more server computers, including non-transitory computer readable recording media on a server computer. This readable media contains the program instructions for accomplishing various steps described above. In the context of this document, a computer-readable recording medium can be any medium that can contain or store programming for use by or in connection with an execution system, apparatus, or device. Such computer readable media may be stored on a memory, where a memory is any device capable of storing a computer readable medium and capable of being accessed by a computer. A memory may include additional features. A computer may include a processor. A processor can be any device suitable to access a memory and execute a program stored thereon.

The above examples are included for illustrative purposes only and are not intended to limit the scope of the disclosure. Many variations to those described above are possible. Since modifications and variations to the examples described above will be apparent to those of skill in this art, it is intended that this disclosure be limited only by the scope of the appended claims.

1. A method of wireless communication between a first electronic device and a second electronic device, comprising:
providing information symbols to the first electronic device, the information symbols provided audibly or visually by the second electronic device and comprising a wireless communication address of the second electronic device;
transmitting a pairing request from the first electronic device to the second electronic device using the wireless communication address;
obtaining a pairing password by accessing a database; and
establishing a wireless communication channel between the first electronic device and the second electronic device using the obtained pairing password.

2. The method of claim 1, wherein the information symbols comprise at least one of a two-dimensional code, a bar code, and a voice code.

3. The method claim 1, wherein the information symbols are encrypted or encoded.

4. The method of claim 1, wherein providing information symbols comprises at least one of obtaining an optical representation of the information symbols, obtaining an audible representation of the information symbols, and receiving characters representing the information symbols.

5. The method of claim 1, further comprising displaying a notification on the first electronic device that a wireless communication channel has been established.

6. The method of claim 1, further comprising transmitting to the second electronic device at least one of an operation instruction and identification information of a third electronic device, and wherein the at least one of an operation instruction and the identification information instructions is encoded or encrypted.

7. The method of claim 6, further comprising transmitting the operation instructions from the first electronic device to the second electronic device.

8. The method of claim 6, further comprising transmitting the identification information of the third electronic device from the first electronic device to the second electronic device.

9. The method of claim 8, further comprising establishing wireless communication between the third electronic device and the second electronic device based on the transmitted identification information.

10. The method of claim 8, wherein the transmitted identification information comprises at least one of a Bluetooth address of the third electronic device, an IP address of the third electronic device, and a MAC address of the third electronic device.

11. The method of claim 1, wherein the first electronic device is a master device and the second electronic device is a slave device in the wireless communication.

12. The method of claim 1, wherein the wireless communication channel is a Bluetooth communication channel.

13. The method of claim 1, wherein the wireless communication operates according to a short range radio communication standard.

14. The method of claim 13, wherein the standard is a Bluetooth standard.

15. The method of claim 13, wherein the standard is a Wi-Fi Direct standard.

16. The method of claim 13, wherein the wireless communication is configured to operate at a range of no more than 100 meters.

17. A first electronic device for wireless communication with a second electronic device, comprising:
an information collection module to collect information symbols provided audibly or visually by the second electronic device, the information symbols comprising a wireless communication address of the second electronic device;
a data transmission module to wirelessly transmit a pairing request from the first electronic device to the second electronic device using the wireless communication address; and
a database for storing a pairing password, wherein the database is accessed and the pairing password is retrieved, and wherein the wireless communication is established over a wireless communication channel when the retrieved pairing password corresponds to a preset password.

18. The method of claim 17, wherein the information symbols comprises at least one of a two-dimensional code, a bar code, and a voice code.

19. The method of claim 17, wherein providing information symbols comprises at least one on of obtaining an optical representation of the information symbols, obtaining an audible representation of the information symbols, and receiving characters representing the information symbols.

20. A wireless communication system comprising:
a first electronic device; and
a second electronic device providing audible or visual information signals, the information symbols comprising a wireless communication address of the second electronic device, wherein the first electronic device
collects the information symbols and
transmits a pairing request to the second electronic device based on the wireless communication address.
